(19) United States
(12) Patent Application Publication
(10) Pub. No.: US 2008/0146048 A1
(43) Pub. Date: Jun. 19, 2008

(54) PRINTED CIRCUIT BOARD CONNECTION

(76) Inventor: Hubert Nestler, Leipzig (DE)

Correspondence Address: Striker, Striker & Stenby, 103 East Neck Road, Huntington, NY, 11743, US

(21) Appl. No.: 11/950,825

(22) Filed: Dec. 5, 2007

(30) Foreign Application Priority Data
Dec. 13, 2006 (DE) 10 2006 058 731.6

(51) Int. Cl. H01R 12/14; B23P 11/00

(52) U.S. Cl. 439/65; 29/831

(57) ABSTRACT

A printed circuit board connection has a first printed circuit board that includes a nonconductive plate-shaped first substrate with at least one first conductor track on the upper side, a second printed circuit board including a nonconductive plate-shaped second substrate with at least one second conductor track on the underside, with the first conductor track and the second conductor track being electrically conductively connected by solder. On the upper side of the second substrate, a third conductor track is provided, which is diametrically opposite the second conductor track, and the second conductor track and the third conductor track are connected electrically conductively to one another via at least one opening in the second substrate, in order to make a heat-conducting connection of the heated soldering die with the solder.

### CROSS-REFERENCE TO A RELATED APPLICATION

The invention described and claimed hereinbelow is also described in German Patent Application DE 10 2006 058 731.6 filed on Dec. 13, 2006. This German Patent Application, whose subject matter is incorporated here by reference, provides the basis for a claim of priority of invention under 35 U.S.C. 119(a)-(d).

### BACKGROUND OF THE INVENTION

The invention relates to a connection of two printed circuit boards and to a method for producing it.

From East German Patent Disclosure DD 147 512, ironing soldering devices for soldering electrical components to the conductor tracks of a printed circuit board are known. In ironing soldering, before the soldering operation takes place, solder is applied to the printed circuit board galvanically or by means of a paste. Next, the components are mounted on the printed circuit board. In the ironing soldering system, a heated die is pressed against the metal terminal pins of the components, so that the solder applied there beforehand melts, whereupon the components are connected electrically conductively to the conductor tracks of the printed circuit board. An essential advantage of ironing soldering is that a plurality of terminal pins can be soldered simultaneously.

It is also known for two printed circuit boards to be joined by ironing soldering. This is appropriate for instance whenever a flexible printed circuit board is to be used as a connection line between two further printed circuit boards. By means of the direct soldering, separate plug-type connectors can be dispensed with.

Here as well, solder is applied to the conductor tracks of the first printed circuit board. The second printed circuit board is then placed on the first printed circuit board in such a way that the conductor tracks to be soldered rest on one another, so that the solder applied beforehand is located at the soldering points between the conductor tracks. The heated die is then pressed from the side of the second printed circuit board facing away from the soldering side. The heat of the die flows through the printed circuit board and melts the solder, causing the conductor tracks of both printed circuit boards to be electrically conductively joined to one another.

A disadvantage of the above method is that the heat has to flow through the electrically insulating substrate of the printed circuit board. Electrically insulating components, however, have very low thermal conductivity. In ironing soldering, only an extremely thin printed circuit board can therefore be provided on a side toward the die. For instance, a polyimide printed circuit board with a thickness of only 70 μm is suitable.

### SUMMARY OF THE INVENTION

The object of the invention is to create a printed circuit board connection in which thicker printed circuit boards can be soldered using an ironing soldering system. A further object is to minimize unwanted heating up of the printed circuit board so that it will not be damaged in the soldering process.

In keeping with these objects and with others which will become apparent hereinafter, one feature of the present invention resides, briefly stated, in a printed circuit board connection, comprising a first printed circuit board including a nonconductive, plate-shaped first substrate with at least one first conductor track on an upper side; a second printed circuit board including a nonconductive plate-shaped second substrate with at least one second conductor track on an underside; a solder electrically conductively connecting said first conductor track and said second conductor track; a third conductor track provided on an upper side of said second substrate diametrically opposite to said second conductor track, wherein said second substrate has at least one opening via which said second conductor track and said third conductor track are connected electrically conductively to one another.

The third conductor track on the upper side of the second substrate is connected electrically to the second conductor track via an opening. Electrically conductive materials such as copper or aluminum have substantially higher thermal conductivity than the electrically nonconductive substrate. When the soldering die is placed on the third conductor track, its heat can therefore flow with little resistance via the electrically conductive connection to the second conductor track, where it can melt the solder. As a result, unnecessary heating of the substrate is simultaneously avoided.

The aforementioned openings are preferably circular, so that they can be made by drilling. In printed circuit board production, typically only the surface of the wall of the opening is provided with a conductive layer. The remaining cross section is incidentally filled up when the solder is applied, so that the solder can also enter into direct contact with the die. In the event that the opening, before soldering, was not, or not entirely, filled with solder, that lack is necessarily overcome as soon as a small quantity of solder has been liquefied, since the liquid solder has a tendency to fill up the entire opening.

It has been demonstrated that the heat transfer from the die to the soldering point is greater when a plurality of directly adjacent openings are employed than when a single opening having the same cross-sectional area is used. The smaller openings are also better filled with the liquid solder, if necessary.

Moreover, the area of the third conductor track should be large enough that the heat transfer between the die and the conductor track is as low in resistance as possible. The area of the third conductor track should therefore amount to at least 1 mm².

The proposed printed circuit board connection is especially suitable for flexible printed circuit boards having a thickness of 150 to 1000 μm, and in particular for multilayer printed circuit boards, since they cannot be produced thin enough to be suitable for ironing soldering without the openings according to the invention. In multilayer printed circuit boards, the substrate has a plurality of layers that are glued to one another, and further conductor tracks are located between the layers. For substrate layers, polyimide is especially suitable as a material. For the gluing, acrylic adhesive is especially suitable. These materials are capable of resisting the unavoidable heating that occurs in ironing soldering.

It is also proposed that the second printed circuit board is provided on the upper side with solder stop paint, and the third conductor tracks, in at least some portions, are not covered with solder stop paint. With solder stop paint, the liquid solder is prevented from moistening the covered areas of the printed circuit board, so that short circuits between the conductor tracks are avoided. The third conductor tracks, however, should have unhindered contact with the die for the sake of an optimal heat transfer. Moistening of the die with liquid solder is prevented by means of a suitable die material, such as tungsten.

An especially reliable soldering process is obtained if the die is in contact with the upper side of the second printed circuit board for from 5 to 30 seconds, preferably 10 to 20 seconds.

To prevent uncontrolled flowing away of the liquid solder, it is proposed that the die is not heated up until it is in contact with the second printed circuit board. It is even better if the die is not heated up until the compression force against the second printed circuit board amounts to at least 20 N. Once the contact with the second printed circuit board has been ended, the die can be cooled down again, specifically preferably by switching off the electrical heating. However, active cooling using a separate cooling medium may also be provided.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a rough, schematic cross section through a printed circuit board connection of the invention; and

FIG. 2 is a plan view of the second printed circuit board of FIG. 1.

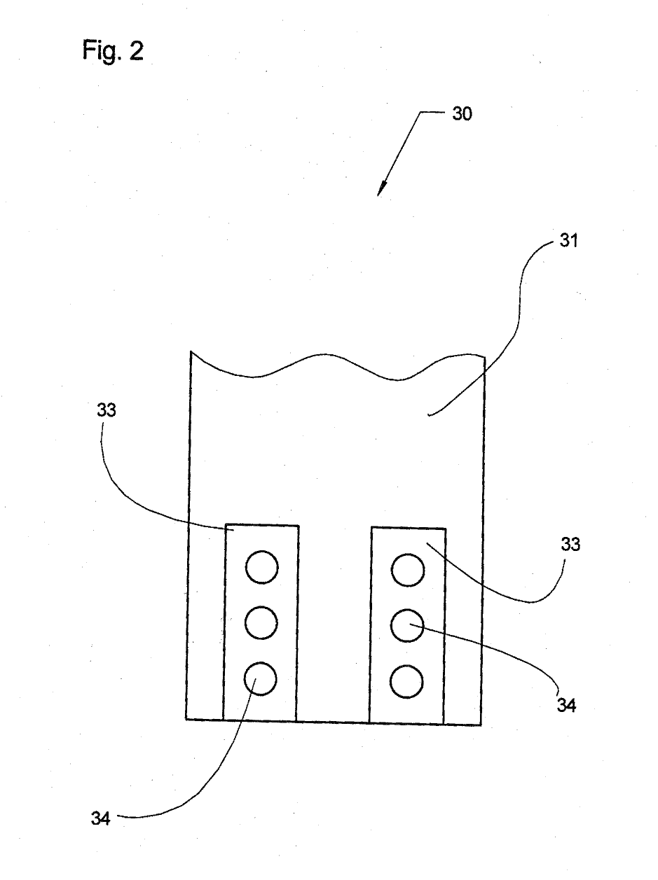

### DESCRIPTION OF THE PREFERRED EMBODIMENTS

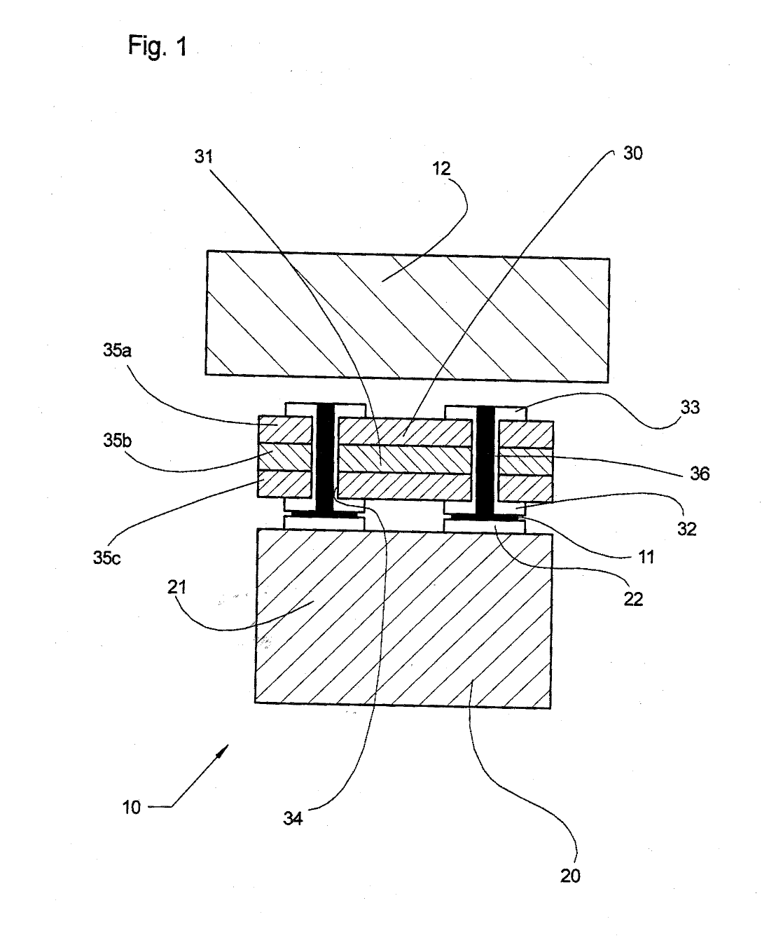

In FIG. 1, a printed circuit board connection 10 of the invention is shown. It comprises a lower, first printed circuit board 20 and an upper, second printed circuit board 30. The first substrate 21 of the first printed circuit board is a glass-fiber-reinforced plate which is provided with two first conductor tracks 22 made of copper. The first conductor tracks are connected to electrical components, not shown.

The second printed circuit board 30 is embodied as a flexible multilayer printed circuit board. It includes a second substrate 32, comprising three substrate layers 35a, b, c. The polyimide layers 35a and 35c are 25 μm thick; the polyimide layer 35b is 50 μm thick. The layers are glued using acrylic adhesive, not shown, that has a layer thickness of 25 μm. On both sides of the substrate layer 35b, copper conductor tracks, not shown, with a thickness of 18 μm are provided.

On the underside of the second printed circuit board 30, two second conductor tracks 32 are provided, which are 35 μm thick. The shape of the second conductor track, in the region of the soldering point, is made complementary to that of the first conductor tracks. The second conductor tracks are connected to contact faces on the diametrically opposite end of the printed circuit board, so that the second, flexible printed circuit board as it were forms a flexible line with two wires.

On the upper side of the second printed circuit board, two third conductor tracks 33 are provided, which in the soldering region are made complementary to the first and second conductor tracks. The third conductor tracks serve primarily to establish a large-area heat transfer to the die 12 in the ironing soldering system.

In addition, between each second and third conductor track (32; 33), three openings 34 each are provided in the second substrate 31. The wall of the openings is provided with a copper conductive layer 36, so that even in the unsoldered state, there is electrical contact between the second and third conductor tracks. Both surfaces of the second printed circuit board are furthermore provided with solder stop paint, specifically with a layer thickness of 25 to 35 μm, at the points that are not intended to be moistened with solder.

Before the soldering, the underside of the second printed circuit board 30 is provided with pastelike solder at the soldering points, and the solder also reaches the opening. It should be noted here that the view in FIG. 1 is greatly exaggerated in terms of thickness. In actuality, the diameter of the circular opening is substantially greater than its height. The pastelike solder can now be briefly melted as needed, so that it will adhere better to the second printed circuit board.

Next, the second printed circuit board 30 is placed on the first printed circuit board 20 in such a way that the first and second conductor tracks 22; 32 are located precisely one above the other. After that, the die 12 is pressed from above against the sandwich. As soon as a pressing force of at least 20 N is reached, the die 12 is electrically heated briefly (for 4 to 5 seconds). The heat of the die then flows, via the electrically conductive connection that is formed by the third conductor tracks 33 and the conductive layer 36, to the second conductor tracks 32, so that the solder melts there and moistens all the copper surfaces that are not provided with solder stop paint. The molten solder now enters directly into contact with the die as well, so that the thermal conduction is improved still further.

The die then presses the two printed circuit boards against one another for 15 seconds, until the solder has cooled. The first and second conductor tracks 22; 32 are thus firmly and electrically conductively joined together.

It will be understood that each of the elements described above, or two or more together, may also find a useful application in other types of constructions differing from the type described above.

While the invention has been illustrated and described as embodied in a printed circuit board connection, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A printed circuit board connection, comprising a first printed circuit board including a nonconductive plate-shaped first substrate with at least one first conductor track on an upper side; a second printed circuit board including a nonconductive plate-shaped second substrate with at least one second conductor track on an underside; a solder electrically conductively connecting said first conductor track and said second conductor track; a third conductor track provided on an upper side of said second substrate diametrically opposite to said second conductor track, wherein said second substrate has at least one opening via which said second conductor track and said third conductor track are connected electrically conductively to one another.

2. A printed circuit board connection as defined in claim 1, wherein said opening in said second substrate is at least partially filled with said solder.

3. A printed circuit board connection as defined in claim 1; further comprising a plurality of said openings between said first and second conductor tracks.

4. A printed circuit board connection as defined in claim 3, wherein said openings are located immediately adjacent to one another.

5. A printed circuit board connection as defined in claim 1, wherein said third conductor track had a surface area which amounts to at least 1 mm².

6. A printed circuit board connection as defined in claim 1, wherein said second printed circuit board is flexible and had a thickness between 150 and 1000 μm.

7. A printed circuit board connection as defined in claim 1, wherein said second substrate has a plurality of layers which are glued to one another, further comprising further conductor tracks located between said layers.

8. A printed circuit board connection as defined in claim 1, wherein said second printed circuit board is provided on an upper side with a solder stop paint, while said third conductor track, in at least some portions, is not covered with a solder stop paint.

9. A method of connecting a first printed circuit board that includes a nonconductive plate-shaped first substrate with at least one first conductor track on an upper side and a second printed circuit board including a nonconductive plate-shaped second substrate with at least one second conductor track on an upper side, comprising the steps of pressing the second conductor track by a heated die on an upper side of the second printed circuit board against the first conductor track; providing a solder between the first and second conductor tracks; and transmitting heat of the die to a soldering point via an electrically conductive connection with the second conductor track.

10. A method as defined in claim 9, further comprising keeping the die in contact with the upper side of the second printed circuit board from 5 to 30 seconds.

11. A method as defined in claim 10, wherein said keeping includes providing the contact of the die with the upper side of the second printed circuit board for 10-20 seconds.

12. A method as defined in claim 9, further comprising heating the die until it is in contact with the second printed circuit board, and providing a pressing force against the second printed circuit board to amount to at least 20 N.
